(19) United States
(12) Patent Application Publication
(10) Pub. No.: US 2013/0266786 A1
(43) Pub. Date: Oct. 10, 2013

(54) Polymers, Polymer Blends, and Articles Made Therefrom

(71) Applicants: Alan M. Malakoff, Houston, TX (US); Richard W. Halle, Houston, TX (US); Adriana S. Silva, Houston, TX (US); Steve A. Best, The Woodlands, TX (US)

(72) Inventors: Alan M. Malakoff, Houston, TX (US); Richard W. Halle, Houston, TX (US); Adriana S. Silva, Houston, TX (US); Steve A. Best, The Woodlands, TX (US)

(73) Assignee: ExxonMobil Chemical Patents Inc., Baytown, TX (US)

(21) Appl. No.: 13/796,491

(22) Filed: Mar. 12, 2013

Related U.S. Application Data
(60) Provisional application No. 61/621,202, filed on Apr. 6, 2012.

(30) Foreign Application Priority Data
May 24, 2012 (EP) 12169310.5

(51) Int. Cl. C08F 10/02

(52) U.S. Cl. CPC C08F 10/02
USPC 428/220; 526/352.2; 526/348.5

(57) ABSTRACT

Polymer compositions including an ethylene-based polymer having a melt index of from about 0.1 g/10 min to about 5.0 g/10 min; a melt index ratio of from about 15 to about 30; a weight average molecular weight (Mw) of from about 20,000 to about 200,000; a molecular weight distribution (Mw/Mn) of from about 2.0 to about 4.5; and a density of from 0.900 to 0.920 g/cm³. Films having a thickness of 1 mil show a difference between the maximum seal strength and the minimum seal strength over the ranges of temperatures between 95.0° C. and 140.0° C. of ≦1.00×10² grams/cm.

### CROSS REFERENCE TO RELATED APPLICATIONS

This application claims priority to and the benefit of U.S. Provisional Patent Application Ser. No. 61/621,202, filed Apr. 6, 2012 and EP Patent Application No. 12169310.5 filed on May 24, 2012, and is related to U.S. patent application Ser. No. 11/789,391, filed Apr. 24, 2007, which claims the benefit of U.S. Provisional Patent Application Ser. No. 60/809,509, filed May 31, 2006, the disclosures of which are incorporated by reference in their entireties.

### FIELD OF THE INVENTION

The present invention is directed to linear low density polyethylene polymers, polymer blends, methods for making the same, and articles made therefrom. In particular, provided are linear low density polyethylene polymers suitable for films having improved balance of properties and relatively constant seal strength over a broad range of sealing temperatures.

### BACKGROUND OF THE INVENTION

Linear low density polyethylenes, and blends and articles made therefrom, are generally known in the art. Such polymers and polymer blends have typically been made from a linear low density polyethylene produced using a Ziegler-Natta catalyst in a gas phase process.

Processes for the polymerization of monomers utilizing a bulky ligand hafnium transition metal metallocene-type catalyst compound have been described. The hafnium transition metal metallocene-type catalyst compound used in the process comprises at least one cyclopentadienyl ligand including at least one linear or isoalkyl substitutent of at least three carbon atoms.

A single reactor process for the polymerization of monomers to make ethylene polymers utilizing a bulky ligand hafnium transition metal metallocene-type catalyst compound has been described.

Metallocene-catalyzed polyethylenes having relatively broad composition distribution (CDBI) and relatively broad molecular weight distribution, and films produced from such polymers are also known.

Other films produced from polyethylene obtained using a hafnium-based metallocene catalyst and methods for manufacturing the films are also described.

While many prior art documents describe processes and polymers using the same monomers as those described herein and similar processes to those described herein, there still remains a need for polyethylene compositions having an improved balance of properties. Improvements in properties that allow for down-gauging of films are particularly desirable for reducing environmental impact and cost of films because less polymer can be used to make a film that meets particular performance expectations. Likewise, polymers that provide films with a stable seal strength over a wide range of temperatures are desirable because the seal strength would not be detrimentally affected by fluctuations in the sealing process. Polymers that provide such seal performance and have low seal initiation temperatures (SIT) are even more desirable. Consequently, polyethylenes providing improved toughness without detrimentally affecting processability and seal performance are desired.

### SUMMARY OF THE INVENTION

In one aspect, embodiments of the invention provide polymer compositions comprising an ethylene-based polymer having 1) a melt index of from about 0.1 g/10 min to about 5.0 g/10 min; 2) a melt index ratio of from about 15 to about 30; 3) a weight average molecular weight (Mw) of from about 20,000 to about 200,000; 4) a molecular weight distribution (Mw/Mn) of from about 2.0 to about 4.5; and 5) a density of from 0.900 to 0.920 g/cm³. Some compositions also exhibit a difference between the maximum seal strength and the minimum seal strength over the range of temperatures between 95.0° C. and 140.0° C. which is ≦1.00×10² grams/cm. Optionally the ethylene-based polymer is produced by gas-phase polymerization of ethylene with a catalyst having as a transition metal component a bis(n-C₃₋₄ alkyl cyclopentadienyl) hafnium compound, wherein said transition metal component comprises from about 95 mole % to about 99 mole % of said hafnium compound.

In another aspect, embodiments of the invention provide an ethylene/alpha-olefin copolymer characterized by: a melt index of from about 0.1 g/10 min to about 5.0 g/10 min; a melt index ratio of from about 15 to about 30; a weight average molecular weight (Mw) of from about 20,000 to about 200,000; a molecular weight distribution (Mw/Mn) of from about 2.0 to about 4.5; and a density of from 0.900 to 0.920 g/cm³; and having a Dart A Impact >1200 g/mil and an average 1% Secant Modulus of ≧2.65×10⁴ psi when formed into a film.

In still another aspect, embodiments of the invention provide a film comprising an ethylene/alpha-olefin copolymer characterized by: a melt index of from about 0.1 g/10 min to about 5.0 g/10 min; a melt index ratio of from about 15 to about 30; a weight average molecular weight (Mw) of from about 20,000 to about 200,000; a molecular weight distribution (Mw/Mn) of from about 2.0 to about 4.5; a density of from 0.900 to 0.920 g/cm³; and having a Dart A Impact >1200 g/mil and an average 1% Secant Modulus of ≧2.65×10⁴ psi.

In yet another aspect, embodiments of the invention provide a film comprising at least one layer including an ethylene/alpha-olefin copolymer characterized by: a melt index of from about 0.1 g/10 min to about 5.0 g/10 min; a melt index ratio of from about 15 to about 30; a weight average molecular weight (Mw) of from about 20,000 to about 200,000; a molecular weight distribution (Mw/Mn) of from about 2.0 to about 4.5; and a density ≦0.9160 g/cm³; the film having an average 1% Secant Modulus of ≧2.65×10⁴ psi and/or a Dart A Impact >1200 g/mil.

Blends of the ethylene-based polymer compositions may also include a linear low density polyethylene (LLDPE) polymer other than the ethylene-based polymer and/or a second polyethylene polymer or copolymer (e.g., a very low density polyethylene (VLDPE), a non-linear low density polyethylene (LDPE), a medium density polyethylene (MDPE), a high density polyethylene (HDPE), a differentiated polyethylene (DPE), another polymer, or combinations of the foregoing).

Also provided, are articles made from both the first LLDPE polymer alone and also from the polyethylene blends described herein. These articles include monolayer and multilayer blown, extruded, and/or cast stretch and/or shrink films; wire and cable coating compositions; articles formed by injection molding, rotational molding, blow molding, extrusion coating, and/or casting; and combinations thereof.

Particular embodiments provide films comprising a Layer A comprising at least one ethylene-based polymer described above; and optionally, a Layer B in surface contact with Layer A. Layer A is preferably a surface layer, particularly a heat-sealable surface layer.

### BRIEF DESCRIPTION OF THE FIGURE

FIG. 1 shows the heat seal behavior of exemplary polymers compositions according to the invention compared to conventional similar polymers.

### DETAILED DESCRIPTION OF THE INVENTION

Described herein are polymer compositions comprising an ethylene-based polymer that provides improved toughness without detrimentally affecting processability and seal performance. Particularly, the ethylene-based polymers and films made therefrom have a stable seal strength over a wide range of temperatures. Some polymers have improved stiffness-toughness characteristics.

Various specific embodiments, versions, and examples are described herein, including exemplary embodiments and definitions that are adopted for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

Throughout the description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein. For instance, all numbers disclosed herein are approximate values, regardless whether the word “about” or “approximate” is used in connection therewith. They may vary by 1%, 2%, 5%, and sometimes, 10% to 20%. Whenever a numerical range with a lower limit, R^{L} and an upper limit, R^{U}, is disclosed, any number falling within the range is specifically disclosed. In particular, the following numbers within the range are specifically disclosed: R=R^{L}+k*(R^{U}−R^{L}), wherein k is a variable ranging from 1% to 100% with a 1% increment, i.e., k is 1%, 2%, 3%, 4%, 5%, . . . , 50%, 51%, 52%, . . . , 95%, 96%, 97%, 98%, 99%, or 100%. Moreover, any numerical range defined by two R numbers as defined in the above is also specifically disclosed.

### DEFINITIONS

For the purposes of this disclosure, the following definitions will apply.

As used herein, weight percent (wt. %), unless noted otherwise, means a percent by weight of a particular component based on the total weight of the mixture containing the component. For example, if a mixture or blend contains three grams of compound A and one gram of compound B, then the compound A comprises 75 wt. % of the mixture and the compound B comprises 25 wt. %.

As used herein the term “polymer” means a composition including a plurality of macromolecules, the macromolecules containing recurring units derived from one or more monomers. The term “copolymer” refers to polymers formed by the polymerization of at least two different monomers. For example, the term “copolymer” includes the copolymerization reaction product of ethylene and an alpha-olefin (α-olefin), such as 1-hexene, or a cyclic olefin, e.g., norbornene. However, the term “copolymer” is also inclusive of, for example, the copolymerization of a mixture of ethylene, propylene, 1-hexene, and 1-octene.

The term “polyolefin” means a polymer containing recurring units derived from olefin, e.g., poly-α olefin such as polypropylene and/or polyethylene.

“Polyethylene” and “ethylene-based polymer” refer to a polyolefin containing recurring ethylene-derived units, e.g., polyethylene homopolymer, polyethylene copolymer, etc., wherein >50%, or preferably >70% or >85%, (by number) of the recurring units are derived from ethylene monomer.

Molecular weight distribution (“MWD”) is equivalent to the expression M_{w}/Mₙ. The expression M_{w}/Mₙ is the ratio of the weight average molecular weight (M_{w}) to the number average molecular weight (Mₙ). The weight average molecular weight is given by:

$${M}_{w} = \frac{{\sum }_{i} {n}_{i} {M}_{i}^{2}}{{\sum }_{i} {n}_{i} {M}_{i}}$$

The number average molecular weight is given by:

$${M}_{n} = \frac{{\sum }_{i} {n}_{i} {M}_{i}}{{\sum }_{i} {n}_{i}}$$

The z-average molecular weight is given by:

$${M}_{z} = \frac{{\sum }_{i} {n}_{i} {M}_{i}^{3}}{{\sum }_{i} {n}_{i} {M}_{i}^{2}}$$

where nᵢ in the foregoing equations is the number fraction of molecules of molecular weight Mᵢ. Measurements of M_{w}, M_{z}, and Mₙ are typically determined by Gel Permeation Chromatography as disclosed in Macromolecules, Vol. 34, No. 19, pg. 6812 (2001).

Composition distribution breadth index (“CDBI”) is defined as the weight percent of the copolymer molecules having a comonomer content within 50% of the median total molar comonomer content. The CDBI of a copolymer is readily determined utilizing well known techniques for isolating individual fractions of a sample of the copolymer. One such technique is Temperature Rising Elution Fraction (TREF), as described in Wild, et al., J. Poly. Sci., Poly. Phys. Ed., Vol. 20, pg. 441 (1982) and U.S. Pat. No. 5,008,204, which are fully incorporated herein by reference.

Solubility distribution breadth index (“SDBI”) is used as a measure of the breadth of the solubility distribution curve for a given polymer. The procedure used herein for calculating SDBI is as described in pages 16 through 18 of PCT Patent Application No. WO 93/03093, published Feb. 18, 1993.

Both CDBI and SDBI may be determined using data obtained via CRYSTAF. In such cases, a commercial CRYSTAF model 200 instrument (Polymer Char S.A.) is used for chemical composition distribution (CCD) analysis. Approximately 20 to 30 mg of polymer is placed into each reactor and dissolved in 30 mL of 1,2-dichlorobenzene at 160° C. for approximately 60 minutes, then allowed to equilibrate for approximately 45 minutes at 100° C. The polymer solution is then cooled to either 30° C. (standard procedure) or 0° C. (cryo procedure) using a cooling rate of 0.2° C./min. A two wavelength infrared detector is then used to measure the polymer concentration during crystallization (3.5 μm, 2853 cm⁻¹ sym. stretch) and to compensate for base line drifts (3.6 μm) during the analysis time. The solution concentration is monitored at certain temperature intervals, yielding a cumulative concentration curve. The derivative of this curve with respect to temperature represents the weight fraction of crystallized polymer at each temperature. In both standard and cryo procedures, any resin in solution at the temperature to which the solution is cooled is defined as “% solubles.” The cryo procedure outlined above, i.e., cooling to 0° C., typically provides greater detail, especially for amorphous samples that tend to stay in solution at or around 30° C.

### Ethylene-Based Polymers

The ethylene-based polymers described herein are typically linear low density polyethylene (LLDPE) polymers. As used herein, the terms “linear low density polyethylene” and “LLDPE,” when used to refer to the inventive polymers, refer to a polyethylene homopolymer or, preferably, copolymer having minimal long chain branching and a density generally from about 0.900 g/cm³ to about 0.920 g/cm³. Polymers having more than two types of monomers, such as terpolymers, are also included within the term “copolymer” as used herein.

The LLDPEs may have a broad composition distribution as measured by CDBI or SDBI. Further details of determining the CDBI or SDBI of a copolymer are known to those skilled in the art. See, for example, PCT Patent Application No. WO 93/03093, published Feb. 18, 1993.

Polymers produced using the catalyst systems described herein may have a CDBI less than 50%, preferably less than 40%, and more preferably less than 30%. In one embodiment, the polymers have a CDBI of from 20% to 50%. In another embodiment, the polymers preferably have a CDBI of from 20% to 35%, more preferably from 25% to 28%.

LLDPE polymers produced using the catalyst systems described herein may have an SDBI greater than 15° C., or greater than 16° C., or greater than 17° C., or greater than 18° C., or greater than 19° C., or greater than 20° C. In one embodiment, the polymers have a SDBI of from about 18° C. to about 22° C. In another embodiment, the polymers have a SDBI of from about 18.7° C. to about 21.4° C. In another embodiment, the polymers have a SDBI of from about 20° C. to about 22° C.

In one aspect, the polymers have a density in the range of from 0.900 g/cm³ to 0.920 g/cm³, more preferably in the range of from 0.905 g/cm³ to 0.920 g/cm³, and most preferably in the range of from 0.910 g/cm³ to 0.920 g/cm³. Density is measured in accordance with ASTM D-1238.

The LLDPEs typically have a weight average molecular weight of from about 20,000 to about 200,000. Preferably, the weight average molecular weight is from about 25,000 to about 150,000.

The polymers have a molecular weight distribution (M_{w}/Mₙ) of from about 2.0 to about 4.5, preferably from about 2.5 to about 4.0 or about 3.0 to about 4.0.

The polymers have a ratio of z-average molecular weight to weight average molecular weight of greater than about 1.5, or greater than about 1.7, or greater than about 2.0. In one embodiment, this ratio is from about 1.7 to about 3.5. In yet another embodiment, this ratio is from about 2.0 to about 3.0, or from about 2.2 to about 3.0.

The polymers made by the described processes can, in certain embodiments, have a melt index (MI) or (I_{2.16}) as measured by ASTM D-1238-E (190/2.16) in the range from about 0.1 to about 5.0 dg/min, preferably from about 0.3 to about 2.0 dg/min, more preferably from about 0.5 to about 1.0 dg/min.

In one embodiment, the polymers have a melt index ratio (I_{2.16}/I_{2.16}) (I_{2.16} is measured by ASTM D-1238-F) (190/21.6) of from about 15 to about 30.

In some embodiments, LLDPE polymers exhibit a melt index ratio of from about 20 to about 30, or from about 25 to about 30, or from about 25 to about 28.

In some embodiments, LLDPE polymers exhibit a melting temperature as measured by differential scanning calorimetry (“DSC”) of from about 90° C. to about 130° C. An exemplary method of identifying a composition's melting temperature is determined by first pressing a sample of the composition at elevated temperature and removing the sample with a punch die. The sample is then annealed at room temperature. After annealing, the sample is placed in a differential scanning calorimeter, e.g., Perkin Elmer 7 Series Thermal Analysis System, and cooled. Then the sample is heated to a final temperature and the thermal output, ΔH_{f}, is recorded as the area under the melting peak curve of the sample. The thermal output in joules is a measure of the heat of fusion. The melting temperature, Tₘ, is recorded as the temperature of the greatest heat absorption within the range of melting of the sample. This is called the first melt. T_{c1} is the first non-isothermal crystallization temperature, which is recorded as the temperature of greatest heat generation. The sample is then cooled. The sample is reheated to form a second melt, which is more reproducible than the first melt. The peak melting temperature from the second melt is recorded as the second melting temperature, Tₘ. T_{c2} is the second non-isothermal crystallization temperature, and ΔH_{c2} is the second heat of crystallization. Preferably, LLDPE polymers of these embodiments exhibit a second melt temperature of from about 100° C. to about 130° C., or from about 110° C. to about 130° C., or from about 119° C. to about 123° C. Preferably, LLDPE polymers of these embodiments exhibit a first melt temperature of from about 95° C. to about 125° C., or from about 100° C. to about 118° C., or from about 107° C. to about 110° C.

In another embodiment, the polymers produced by the processes described herein, particularly in slurry or gas phase process, contain less than 5 ppm hafnium, generally less than 2 ppm hafnium, preferably less than 1.5 ppm hafnium, more preferably less than 1 ppm hafnium. In an embodiment, the polymer contains in the range of from about 0.01 ppm to about 2 ppm hafnium, preferably in the range of from about 0.01 ppm to about 1.5 ppm hafnium, more preferably in the range of from about 0.01 ppm to 1 or less ppm hafnium.

In one embodiment, the polymerization product is a linear low-density polyethylene (LLDPE) resin produced by polymerization of ethylene and, optionally, an alpha-olefin comonomer having from 3 to 20 carbon atoms, preferably hexene-1. The ethylene-based polymers may have up to about 5 mole % alpha-olefin comonomer incorporated into the copolymer.

The ethylene-based polymers are more easily extruded into film products by cast or blown bubble film processing techniques with lower motor load, higher throughput and reduced head pressure as compared to traditional LLDPE resins of comparable comonomer type and density. The inventive resins have a comparable MI and generally a higher weight average molecular weight than traditional LLDPEs.

The ethylene-based polymers have improved sealing properties, particularly relatively stable seal strength. In practice, a range of temperatures may be used to form seals. This temperature may change depending on the particular equipment used in the sealing process or may change due to changing conditions on the same machine. Thus, a polymer that can provide adequate seal strength under a variety of temperatures is advantageous. Surprisingly, the ethylene-based polymers have a difference between the maximum seal strength and the minimum seal strength over the range of temperatures between 95.0° C. and 140.0° C.≦1.00×10² grams/cm, particularly 0.20×10² grams/cm to 0.85×10² grams/cm, more particularly 0.40×10² grams/cm to 0.60×10² grams/cm.

At least some of the ethylene-based polymers also have an improved seal initiation temperature (SIT). A lower seal initiation temperature, as measured by the temperature at which the seal strength reaches 50.0 grams/cm, is also advantageous because adequate seal strength can be achieved at lower energy costs. Seals are measured in an inner/inner (I/I) configuration such that ethylene-based polymer layer is in contact with itself at a seal pressure=73 psi and a seal time=1 sec with a peel speed=20 in/min. Surprisingly, embodiments of the ethylene-based polymers described herein have a surprisingly lower seal initiation temperature. For example, some ethylene-based polymers have a seal initiation temperature of ≦85.0° C., e.g., about 75.0° C. to 85.0° C., 78.0° C. to 84.0° C., or 80.0 to about 83.0° C. Such lower seal temperatures are surprising, particularly for ethylene-based polymers having relatively high melting point, molecular weight, and/or low melt index. Thus, some ethylene-based polymers have a seal initiation temperature of ≦85.0° C. and a Mw of from about 100,000 g/mol to about 200,000, particularly from about 150,000 g/mol to about 200,000 g/mol; and/or a melt index (I_{2.16}) of from about 0.5 g/10 min to about 1.5 g/10 min, particularly from about 0.70 g/10 min to about 1.0 g/10 min.

In addition to improved sealing properties, some ethylene based polymers also have improved toughness as measured by Dart A Impact strength and average 1% Secant Modulus (i.e., the average of the 1% Secant Modulus in the machine direction (MD) and the 1% Secant Modulus in the transverse direction (TD) measured according to ASTM D-882.) For example, some ethylene-based polymers have a Dart A Impact Strength ≧1.100×10³ g/mil, particularly Strength ≧1.300×10³ g/mil, more particularly 1.300×10³ to 1.500×10³ g/mil; and an average of the MD and TD 1% Secant Moduli ≧26.0 kpsi, particularly ≧28.0 kpsi, more particularly from about 28.0 kpsi to 32.0 kpsi. Some ethylene-based polymers have a MD 1% Secant Modulus of from about 25 kpsi to about 35 kpsi and a TD 1% Secant Modulus of from about 25.0 kpsi to about 35.0 kpsi.

In addition to improved sealing properties and improved toughness, some ethylene-based polymers described herein also have desirable tear and tensile strength. For example, some ethylene polymers have an Elmendorf tear in the machine direction of 200 to about 1000 g/mil, and a tensile strength in the machine direction of from about 6000 to about 9000 psi, and a tensile strength in the transverse direction of from about 5000 to about 8000 psi/mil.

### Catalyst Components and Catalyst Systems

Suitable catalysts include hafnium transition metal metallocene-type catalyst systems for polymerizing one or more olefins. The one or more metallocene catalyst components are represented by the formula:

Cp^{A}Cp^{B}HfXₙ

wherein each X is chemically bonded to Hf, each Cp group is chemically bonded to Hf, and n is 0 or an integer from 1 to 4. Preferably, n is 1 or 2. The ligands represented by Cp^{A} and Cp^{B} may be the same or different cyclopentadienyl ligands or ligands isolobal to cyclopentadienyl, either or both of which may contain heteroatoms and either or both of which may be substituted by a group R. In one embodiment, Cp^{A} and Cp^{B} are independently selected from the group consisting of cyclopentadienyl, indenyl, tetrahydroindenyl, fluorenyl, and substituted derivatives of each.

Independently, each Cp^{A} and Cp^{B} may be unsubstituted or substituted with any one or combination of substituent groups R. Non-limiting examples of substituent groups R include hydrogen radicals, alkyls, alkenyls, alkynyls, cycloalkyls, aryls, acyls, aroyls, alkoxys, aryloxys, alkylthiols, dialkylamines, alkylamidos, alkoxycarbonyls, aryloxycarbonyls, carbomoyls, alkyl- and dialkyl-carbamoyls, acyloxys, acylaminos, aroylaminos, and combinations thereof.

Exemplary hafnocene catalyst systems used to produce LLDPEs are set forth in the description and examples of U.S. Pat. Nos. 6,936,675 and 6,528,597, both of which are fully incorporated herein by reference. The hafnocene catalyst systems used herein produce polymers having higher molecular weight in comparison to zirconocene equivalents at the same or similar polymerization conditions. One suitable hafnocene is bis(n-propyl cyclopentadienyl)hafnium dichloride. Additionally, the substituted hafnocenes used herein tend to produce lower density polymer products than zirconocene equivalents at substantially the same molecular weight.

Further description of catalyst systems are found in U.S. Pat. Nos. 6,242,545; 6,248,845; and 6,956,088, and in U.S. Application Publication Nos. 2005/0171283 A1 and 2005/0215716 A1, all of which are fully incorporated herein by reference.

### Polymerization Process

The hafnium transition metal metallocene-type catalyst compounds and catalyst systems presently employed are suited for the polymerization of monomers, and, optionally, one or more comonomers, in any catalytic polymerization process, solution phase, gas phase, or slurry phase. Preferably, a gas or slurry phase process is used. In particular, the process used to polymerize LLDPEs is as described in the text and examples of U.S. Pat. Nos. 6,936,675 and 6,528,597, which are fully incorporated herein by reference.

In the processes used to manufacture the LLDPEs, the monomer supplied to the polymerization zone is regulated to provide a ratio of ethylene to alpha-olefin comonomer so as to yield a polyethylene having a comonomer content, as a bulk measurement, of from about 0.5 mole % to about 5.0 mole % comonomer. The reaction temperature, monomer residence time, catalyst system component quantities, and molecular weight control agent (such as H₂) may be regulated so as to provide a LLDPE resin having the desired melt index, melt index ratio, weight average molecular weight, molecular weight distribution, and density using methods known in the art.

For example, persons having ordinary skill in the art will recognize that the above-described processes may be tailored to achieve desired ethylene-based polymers. Comonomer to ethylene concentration or flow rate ratios are commonly used to control resin density. Similarly, hydrogen to ethylene concentrations or flow rate ratios are commonly used to control resin molecular weight. In both cases, higher levels of a modifier results in lower values of the respective resin parameter. Gas concentrations may be measured by, for example, an on-line gas chromatograph or similar apparatus to ensure relatively constant composition of recycle gas streams. One skilled in the art will be able to optimize these modifier ratios and the given reactor conditions to achieve a targeted resin melt index, density, and/or other resin properties. This approach was used herein to produce the range of inventive ethylene-based polymers employed in the subsequent data and examples.

Additionally, the use of a process continuity aid, while not required, may be desirable in any of the foregoing processes. Such continuity aids are well known to persons of skill in the art and include, for example, metal stearates.

### Polymer Blends

For the purposes of this disclosure, the following definitions will be generally applicable.

Low density polyethylene (LDPE) may be prepared in high pressure polymerization using free radical initiators, and typically has a density in the range of 0.915-0.935 g/cm³. LDPE is also known as “branched” or “heterogeneously branched” polyethylene because of the relatively large number of long chain branches extending from the main polymer backbone. LDPE has been commercially manufactured since the 1930s and is well known in the art.

Polyethylene in an overlapping density range, i.e., 0.890 to 0.945 g/cm³, typically from 0.915 to 0.945 g/cm³, which is linear and does not contain long chain branching is also known. This traditional “linear low density polyethylene” (LLDPE) can be produced with conventional Ziegler-Natta catalysts, vanadium catalysts, or with metallocene catalysts in gas phase reactors and/or with metallocene catalysts in slurry reactors and/or with any of the hafnocene catalysts described herein in solution reactors. The LLDPE reaction systems are relatively low pressure reactor systems. LLDPE has also been commercially manufactured for a long time (since the 1950s for solution reactors, and since the 1980s for gas phase reactors) and is also well known in the art. LLDPE known in the art and not encompassed by the description of the inventive LLDPEs above will hereinafter be referred to as “traditional LLDPE”.

Very low density polyethylene (VLDPE) is a subset of LLDPE. VLDPEs can be produced by a number of different processes yielding polymers with different properties, but are generally described as polyethylenes having a density typically from 0.890 or 0.900 g/cm³ to less than 0.915 g/cm³. VLDPE is also well known in the art.

Relatively higher density linear polyethylene, typically in the range of 0.930 to 0.945 g/cm³, while often considered to be within the scope of low density polyethylene, is also sometimes referred to as “medium density polyethylene” (MDPE). MDPE can be made in any of the above processes with each of the catalyst systems described herein and, additionally, chrome catalyst systems. MDPEs have also been commercially manufactured for quite some time.

Polyethylene having a still greater density is referred to as “high density polyethylene” (HDPE), i.e., polyethylene having a density greater than 0.945 g/cm³. HDPE is typically prepared with either Ziegler-Natta or chromium-based catalysts in slurry reactors, gas phase reactors, or solution reactors. HDPE has been manufactured commercially for a long time (since the 1950s in slurry systems) and is well known in the art. “Medium-high molecular weight HDPE” is hereinafter defined as HDPE having a Melt Index (MI) ranging from about 0.1 g/10 min to about 1.0 g/10 min.

A further class of polyethylene polymers is “differentiated polyethylene” (DPE). Differentiated polyethylenes are defined herein as those polyethylene polymers that comprise polar comonomers or termonomers. Typical DPEs are well known in the art and include, but are not limited to, ethylene polymers comprising ethylene n-butyl acrylate, ethylene methyl acrylate acid terpolymers, ethylene acrylic acid, ethylene methyl acrylate, zinc or sodium neutralized ethylene acid copolymers, ethylene vinyl acetate, and combinations of the foregoing.

Nothing with regard to these definitions is intended to be contrary to the generic definitions of these resins that are well known in the art. It should be noted, however, that LLDPE may refer to a blend of more than one LLDPE grade/type. Similarly, HDPE may refer to a blend of more than one HDPE grade/type, LDPE may refer to a blend of more than one LDPE grade/type, etc. Generally preferred ethylene polymers and copolymers that are useful include those sold by ExxonMobil Chemical Company in Houston Tex., including those sold as ExxonMobil HDPE, ExxonMobil LLDPE, and ExxonMobil LDPE; and those sold under the EXACT™, EXCEED™, ESCORENE™, EXXCO™, ESCOR™, ENABLE™, NTX™, PAXON™, and OPTEMA™ tradenames.

If any of the resins described herein is produced using a single-site catalyst, it may be (but is not necessarily) identified by the use of an initial lower case “m.” For example, single-site catalyzed linear low density polyethylene manufactured in a gas phase reactor may be abbreviated “mLLDPE.” As used herein, the term “single-site catalyzed polymer” refers to any polymer, copolymer, or terpolymer, and, in particular, any polyolefin polymerized using a single-site catalyst and is used interchangeably with the term “metallocene catalyzed polymer,” wherein both “metallocene catalyzed polymer” and “single-site catalyzed polymer” are meant to include non-metallocene catalyzed single-site catalyzed polymers. As used herein, the term “Ziegler-Natta catalyzed polymer” refers to any polymer, copolymer, or terpolymer, and, in particular, any polyolefin polymerized using a Ziegler-Natta catalyst.

The LLDPE, HDPE, MDPE, LDPE, and DPE contemplated in certain embodiments include ethylene homopolymers and/or ethylene α-olefin copolymers. By “copolymers” is meant combinations of ethylene and one or more α-olefins. In general, the α-olefin comonomers can be selected from those having 3 to 20 carbon atoms, such as C₃ to C₂₀ α-olefins or C₃ to C₁₂ α-olefins. Suitable α-olefin comonomers can be linear or branched or may include two unsaturated carbon-carbon bonds (dienes). Two or more comonomers may be used, if desired. Examples of suitable comonomers include linear C₃ to C₁₂ α-olefins and α-olefins having one or more C₁ to C₃ alkyl branches or an aryl group. Particularly preferred comonomers are 1-butene, 1-hexene, and 1-octene. Specific comonomer examples include propylene; 1-butene; 3-methyl-1-butene; 3,3-dimethyl-1-butene; 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Specifically, the combinations of ethylene with a comonomer may include: ethylene 1-butene; ethylene 1-pentene; ethylene 4-methyl-1-pentene; ethylene 1-hexene; ethylene 1-octene; ethylene decene; ethylene dodecene; ethylene 1-butene 1-hexene; ethylene 1-butene 1-pentene; ethylene 1-butene 4-methyl-1-pentene; ethylene 1-butene 1-octene; ethylene 1-hexene 1-pentene; ethylene 1-hexene 4-methyl-1-pentene; ethylene 1-hexene 1-octene; ethylene 1-hexene decene; ethylene 1-hexene dodecene; ethylene propylene 1-octene; ethylene 1-octene 1-butene; ethylene 1-octene 1-pentene; ethylene 1-octene 4-methyl-1-pentene; ethylene 1-octene 1-hexene; ethylene 1-octene decene; ethylene 1-octene dodecene; combinations thereof and like permutations. It should be appreciated that the foregoing list of comonomers and comonomer combinations are merely exemplary and are not intended to be limiting.

If a comonomer is used, the monomer is generally polymerized in a proportion of from 50.0 wt. % to 99.9 wt. % of monomer, preferably, from 70 wt. % to 99 wt. % of monomer, and more preferably, from 80 wt. % to 98 wt. % of monomer, with from 0.1 wt. % to 50 wt. % of comonomer, preferably, from 1 wt. % to 30 wt. % of comonomer, and more preferably, from 2 wt. % to 20 wt. % of comonomer. For linear polyethylenes, the actual amount of comonomers, comonomer distribution along the polymer backbone, and comonomer branch length will generally define the density range.

In some embodiments, polymer blends include an ethylene-based polymer and one or more HDPE polymers, one or more MDPE polymers, one or more LDPE polymers, one or more traditional LLDPEs, one or more VLDPEs, one or more DPEs, propylene-based polymers, propylene ethylene copolymers, polymers derived from dienes, and combinations thereof. In any of these embodiments, the ethylene-based polymer, the HDPE, MDPE, LDPE, traditional LLDPE, VLDPE, DPE, and other polymer components of the blend can themselves be blends of such polymers.

The blends include at least 0.1 wt. % and up to 99.9 wt. % of the ethylene-based polymer, and at least 0.1 wt. % and up to 99.9 wt. % of the HDPE polymer, with these wt. % based on the total weight of ethylene-based polymer and HDPE polymers of the blend. Alternative lower limits of the ethylene-based polymer can be 5 wt. %, 10 wt. %, 20 wt. %, 30 wt. %, 40 wt. %, or 50 wt. %. Alternative upper limits of the ethylene-based polymer can be 95 wt. %, 90 wt. %, 80 wt. %, 70 wt. %, 60 wt. %, and 50 wt. %. Ranges from any lower limit to any upper limit are within the scope of the invention. Preferred blends include from 5-85 wt. %, alternatively from 10-50 wt. % or from 10-30 wt. % of the ethylene-based polymer. The balance of the weight percentage is the weight of the one or more HDPE, MDPE, LDPE, traditional LLDPE, VLDPE, DPE, etc., polymer components.

Ethylene-based polymers in the blend can include any of the ethylene-based polymers described herein, preferably, a metallocene-catalyzed LLDPE polymer, and, more preferably, a gas-phase produced metallocene-catalyzed LLDPE polymer. In one preferred embodiment, the polymer blend includes an ethylene-based polymer produced by gas-phase polymerization of ethylene and, optionally, an alpha-olefin with a catalyst having as a transition metal component a bis(n-C₃₋₄ alkyl cyclopentadienyl) hafnium compound, wherein the transition metal component comprises from about 95 mole % to about 99 mole % of the hafnium compound. The ethylene-based polymer preferably has a comonomer content of up to about 5 mole %, a melt index of from about 0.1 g/10 min to about 5.0 g/10 min; a melt index ratio of from about 15 to about 30; a weight average molecular weight (Mw) of from about 20,000 to about 200,000; a molecular weight distribution (Mw/Mn) of from about 2.0 to about 4.5; and a density of from 0.900 to 0.920 g/cm³; and a difference between the maximum seal strength and the minimum seal strength over the ranges of temperatures between 95.0° C. and 140.0° C. is ≦1.00×10² grams/cm.

The blends can include any of the HDPE polymers described herein, preferably, a metallocene-catalyzed HDPE polymer, including those produced in gas phase, slurry, and/or solution processes. One particular blend comprises an HDPE having a density greater than about 0.945 g/cm³.

The MDPE in the blend may be any of the MDPE polymers described herein, preferably a metallocene-catalyzed MDPE polymer, including those produced in gas phase, slurry, and/or solution processes.

The LDPE in the blend may be any of the LDPE polymers described herein, including those produced in high pressure processes.

The LLDPE of the blend can include any of the traditional LLDPE polymers described herein, preferably, a metallocene-catalyzed LLDPE polymer, including those produced in low pressure, gas phase, and/or slurry processes. One particular blend comprises a traditional LLDPE having a density from about 0.910 to about 0.945 g/cm³. In some embodiments, the traditional LLDPE polymer may comprise a copolymer of ethylene and at least one α-olefin having from 3 to about 20 carbon atoms which has a composition distribution breadth index (CDBI) of at least 70%, a melt index (MI), measured at 190° C. and 2.16 kg, of from about 0.1 to about 15 g/10 min, a density of from about 0.910 to about 0.945 g/cm³, and a molecular weight distribution (MWD) of from about 2.5 to about 5.5, such as any of those LLDPE compositions or blends described in U.S. Provisional Application Ser. No. 60/798,382, filed May 5, 2006.

The blends can include any of the VLDPE polymers described herein, preferably a metallocene-catalyzed VLDPE polymer, including those produced in gas phase, slurry, and/or solution processes. In some embodiments, the blend comprises a VLDPE having a density less than about 0.915 g/cm³.

Exemplary DPEs suitable for use in blends with the ethylene-based polymers described herein include, but are not limited to, ethylene n-butyl acrylate, ethylene methyl acrylate acid terpolymers, ethylene acrylic acid, ethylene methyl acrylate, zinc or sodium neutralized ethylene acid copolymers, ethylene vinyl acetate, and combinations of the foregoing.

Such blends can also include a polymer other than HDPE, MDPE, LDPE, traditional LLDPE, VLDPE, and DPE. Such other polymers include, but are not limited to, propylene-based polymers, propylene ethylene copolymers, polymers derived from dienes, and combinations of the foregoing. For example, the ethylene-based polymers described herein may be blended with a polymer or polymers derived from conjugated and non-conjugated dienes, such as, for example, (a) straight chain acyclic dienes, such as 1,4-hexadiene and 1,6-octadiene; (b) branched chain acyclic dienes, such as 5-methyl-1,4-hexadiene, 3,7-dimethyl-1,6-octadiene, and 3,7-dimethyl-1,7-octadiene; (c) single ring alicyclic dienes, such as 1,4-cyclohexadiene, 1,5-cyclo-octadiene, tetracyclo-(δ-11,12)-5,8-dodecene, and 1,7-cyclododecadiene; (d) multi-ring alicyclic fused and bridged ring dienes, such as tetrahydroindene, norbornadiene, methyl-tetrahydroindene, dicyclopentadiene (DCPD), bicyclo-(2,2,1)-hepta-2,5-diene, alkenyl, alkylidene, cycloalkenyl, and cycloalkylidene norbornenes, such as 5-methylene-2-norbornene (MNB), 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, and 5-vinyl-2-norbornene (VNB); and (e) cycloalkenyl-substituted alkenes, such as vinyl cyclohexene, allyl cyclohexene, vinyl cyclooctene, 4-vinyl cyclohexene, allyl cyclodecene, and vinyl cyclododecene. Persons of ordinary skill in the art will recognize that a wide variety of polymers, including copolymers, terpolymers, and polymer blends may be blended with the ethylene-based polymers. Such additional blend components, though not particularly described herein, are within the scope and intended spirit of the invention.

In any of these embodiments, the LLDPE polymer, the second polymer, or both, can be blends of such polymers. For example, the LLDPE polymer component of the blend can itself be a blend of two or more LLDPE polymers having the characteristics described herein, and alternatively or additionally, the second polymer component of the blend can itself be a blend having the characteristics described herein.

### Preparation of Blends

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal, glycerol stearates, and hydrogenated rosins; UV stabilizers; heat stabilizers; anti-blocking agents; release agents; anti-static agents; pigments; colorants; dyes; waxes; silica; fillers; talc; and the like.

### End-Use Applications

Any of the foregoing ethylene-based polymer compositions or ethylene-based polymer blends may be used in a variety of end-use applications. Such applications include, for example, monolayer and multilayer blown, extruded, and/or cast stretch and/or shrink films; wire and cable coating compositions; articles formed by injection molding, blow molding, extrusion coating, foaming, and/or casting; and combinations thereof, each of which is described in more detail in the following paragraphs.

Polymers produced by the processes described herein are useful in such forming operations as film, sheet, and fiber extrusion and co-extrusion as well as blow molding, injection molding and rotary molding. Films include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and nonfood-contact applications. Fibers include melt spinning, solution spinning, and melt blown fiber operations for use in woven or non-woven form to make filters, diaper fabrics, medical garments, geotextiles, etc. Extruded articles include medical tubing, wire and cable coatings, geomembranes, and pond liners. Molded articles include single and multi-layered constructions in the form of bottles, tanks, large hollow articles, rigid food containers, and toys, etc.

### Films

The ethylene-based polymers are particularly suited for use in monolayer films or multilayer films. These films may be formed by any number of well known extrusion or coextrusion techniques discussed below. Films may be unoriented, uniaxially oriented, or biaxially oriented. Physical properties of the film may vary depending on the film forming techniques used.

Thus, the invention provides an ethylene/alpha-olefin copolymer characterized by: a melt index of from about 0.1 g/10 min to about 5.0 g/10 min; a melt index ratio of from about 15 to about 30; a weight average molecular weight (Mw) of from about 20,000 to about 200,000; a molecular weight distribution (Mw/Mn) of from about 2.0 to about 4.5; and a density of from 0.900 to 0.920 g/cm³; having a Dart A Impact >1200 g/mil and an average 1% Secant Modulus of ≧2.65×10⁴ psi when formed into a film. Such films can be made on a GEC line having 2½ inch extruder with barrier screw, 6 inch diameter die, 60 mil die gap, and dual lip air ring with chilled air at approximately 50° F. (10° C.) operated at nominal conditions of 150-190 lbs per hour with a 2.5 blow up ratio (BUR) producing 1.0 mil films. The films contained normal processing additives only with no slip, antiblock, or pigment.

Multiple-layer films may be formed by methods well known in the art. The total thickness of multilayer films may vary based upon the application desired. A total film thickness of about 5-100 μm, more typically about 10-50 μm, is suitable for most applications. Those skilled in the art will appreciate that the thickness of individual layers for multilayer films may be adjusted based on desired end-use performance, resin or copolymer employed, equipment capability, and other factors. The materials forming each layer may be coextruded through a coextrusion feedblock and die assembly to yield a film with two or more layers adhered together but differing in composition. Coextrusion can be adapted for use in both cast film or blown film processes.

When used in multilayer films, the ethylene-based polymer may be used in any layer of the film, or in more than one layer of the film, as desired. When more than one layer of the film comprises an ethylene-based polymer, each such layer can be individually formulated, i.e., the layers comprising an ethylene-based polymer can have the same or different chemical composition, density, melt index, thickness, etc., depending upon the desired properties of the film.

To facilitate discussion of different film structures, the following notation is used herein. Each layer of a film is denoted “A” or “B”, where “A” indicates a conventional film layer as defined below, and “B” indicates a film layer formed of any of the ethylene-based polymer or blends thereof. Where a film includes more than one A layer or more than one B layer, one or more prime symbols (′, ″, ′″, etc.) are appended to the A or B symbol to indicate layers of the same type (conventional or inventive) that can be the same or can differ in one or more properties, such as chemical composition, density, melt index, thickness, etc. Finally, the symbols for adjacent layers are separated by a slash (/). Using this notation, a three-layer film having an inner layer comprising ethylene-based polymer disposed between two outer, conventional film layers would be denoted A/B/A′. Similarly, a five-layer film of alternating conventional/inventive layers would be denoted A/B/A′/B′/A″. Unless otherwise indicated, the left-to-right or right-to-left order of layers does not matter, nor does the order of prime symbols, e.g., an A/B film is equivalent to a B/A film, and an A/A′/B/A″ film is equivalent to an A/B/A′/A″ film. The relative thickness of each film layer is similarly denoted, with the thickness of each layer relative to a total film thickness of 100 (dimensionless) indicated numerically and separated by slashes, e.g., the relative thickness of an A/B/A′ film having A and A′ layers of 10 μm each and a B layer of 30 μm is denoted as 20/60/20.

For the various films described herein, the “A” layer can be formed of any material known in the art for use in multilayer films or in film-coated products. Thus, for example, each A layer can be formed of a polyethylene homopolymer or copolymer, and the polyethylene can be, for example, a VLDPE, a LDPE, a LLDPE, a MDPE, a HDPE, or a DPE, as well as other polyethylenes known in the art. The polyethylene can be produced by any suitable process, including metallocene-catalyzed processes and Ziegler-Natta catalyzed processes. Further, each A layer can be a blend of two or more such polyethylenes and can include additives known in the art. Further, one skilled in the art will understand that the layers of a multilayer film must have the appropriate viscosity match.

In multilayer structures, one or more A layers can also be an adhesion-promoting tie layer, such as PRIMACOR™ ethylene-acrylic acid copolymers available from The Dow Chemical Company, and/or ethylene-vinyl acetate copolymers. Other materials for A layers can be, for example, foil, nylon, ethylene-vinyl alcohol copolymers, polyvinylidene chloride, polyethylene terephthalate, oriented polypropylene, ethylene-vinyl acetate copolymers, ethylene-acrylic acid copolymers, ethylene-methacrylic acid copolymers, graft modified polymers, and paper.

The “B” layer comprises an ethylene-based polymer and can be any of such blends described herein. In one embodiment, the B layer is formed of a blend of (a) from 0.1 wt. % to 99.9 wt. % of a first polymer selected from the group consisting of very low density polyethylene, medium density polyethylene, differentiated polyethylene, and combinations thereof; and (b) from 99.9 wt. % to 0.1 wt. % of a second polymer composition comprising an ethylene-based polymer described herein.

The thickness of each layer of the film, and of the overall film, is not particularly limited, but is determined according to the desired properties of the film. Typical film layers have a thickness of from about 1 to about 1000 μm, more typically from about 5 to about 100 μm, and typical films have an overall thickness of from about 10 to about 100 μm.

In further applications, microlayer technology may be used to produce films with a large number of thinner layers. For example, microlayer technology may be used to obtain films having, for example, 24, 50, or 100 layers, in which the thickness of an individual layer is less than 1 μm. Individual layer thicknesses for these films may be less than 0.5 μm, less than 0.25 μm, or even less than 0.1 μm.

In one embodiment, ethylene-based polymers and blends thereof may be utilized to prepare monolayer films, i.e., a film having a single layer, particularly for a heat sealing applications.

In other embodiments, using the nomenclature described above, multilayer films have any of the following exemplary structures: (a) two-layer films, such as A/B and B/B; (b) three-layer films, such as A/B/A′, A/A′/B, B/A/B′, and B/W/B″; (c) four-layer films, such as A/A′/A″/B, A/A′/B/A″, A/A′/B/B′, A/B/A′/B′, A/B/B′/A′, B/A/A′/B′, AB/B′/B″, B/A/W/B″ and B/W/B″/B′″; (d) five-layer films, such as A/A′/A″/A′″/B, A/A′/A″/B/A′″, A/N/B/A″/A′″, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′/B″/B′″, B/A/B′/B″/B′″, B/B′/B″/A/B″/B′″, and B/B′/B″/B′″/B″″; and similar structures for films having six, seven, eight, nine, twenty-four, forty-eight, sixty-four, one hundred, or any other number of layers. It should be appreciated that films having still more layers can be formed using the LLDPE polymers or blends, and such films are within the scope of the invention.

In any of the embodiments above, one or more A layers can be replaced with a substrate layer, such as glass, plastic, paper, metal, etc., or the entire film can be coated or laminated onto a substrate. Thus, although the discussion herein has focused on multilayer films, the films composed of LLDPE polymer blends can also be used as coatings, e.g., films formed of the inventive polymers or polymer blends, or multilayer films including one or more layers formed of the inventive polymers or polymer blends, can be coated onto a substrate such as paper, metal, glass, plastic, and other materials capable of accepting a coating. Such coated structures are also within the scope of the present invention.

As described below, the films can be cast films or blown films. The films can further be embossed, or produced, or processed according to other known film processes. The films can be tailored to specific applications by adjusting the thickness, materials and order of the various layers, as well as the additives in or modifiers applied to each layer.

In one aspect, films containing the polymers and polymer blend compositions, monolayer or multilayer, may be formed by using casting techniques, such as a chill roll casting process. For example, a composition can be extruded in a molten state through a flat die and then cooled to form a film. As a specific example, cast films can be prepared using a cast film line machine as follows. Pellets of the polymer are melted at a temperature typically ranging from about 250° C. to about 300° C. for cast ethylene-based polymers (depending upon the particular resin used), with the specific melt temperature being chosen to match the melt viscosity of the particular resin layers. In the case of a multilayer cast film, the two or more different melts are conveyed to a coextrusion adapter that combines the two or more melt flows into a multilayer, coextruded structure. This layered flow is distributed through a single manifold film extrusion die to the desired width. The die gap opening is typically about 0.025 inches (about 600 μm). The material is then drawn down to the final gauge. The material draw down ratio is typically about 21:1 for 0.8 mil (20 μm) films. A vacuum box, edge pinners, air knife, or a combination of the foregoing can be used to pin the melt exiting the die opening to a primary chill roll maintained at about 80° F. (32° C.). The resulting polymer film is collected on a winder. The film thickness can be monitored by a gauge monitor, and the film can be edge trimmed by a trimmer. A typical cast line rate is from about 250 to about 2000 feet per minute. One skilled in the art will appreciate that higher rates may be used for similar processes such as extrusion coating. One or more optional treaters can be used to surface treat the film, if desired. Such chill roll casting processes and apparatus are well known in the art, and are described, for example, in The Wiley-Encyclopedia of Packaging Technology, Second Edition, A. L. Brody and K. S. Marsh, Ed., John Wiley and Sons, Inc., New York (1997). Although chill roll casting is one example, other forms of casting may be employed.

In another aspect, films containing the polymers and polymer blend compositions, monolayer or multilayer, may be formed using blown techniques, i.e., to form a blown film. For example, the composition can be extruded in a molten state through an annular die and then blown and cooled to form a tubular, blown film, which can then be axially slit and unfolded to form a flat film. As a specific example, blown films can be prepared as follows. The polymer blend composition is introduced into the feed hopper of an extruder, such as a 63.5 mm Egan extruder that is water-cooled, resistance heated, and has a L/D ratio of 24:1. The film can be produced using a 15.24 cm Sano die with a 2.24 mm die gap, along with a Sano dual orifice non-rotating, non-adjustable air ring. The film is extruded through the die into a film cooled by blowing air onto the surface of the film. The film is drawn from the die typically forming a cylindrical film that is cooled, collapsed, and optionally subjected to a desired auxiliary process, such as slitting, treating, sealing, or printing. Typical melt temperatures are from about 175° C. to about 225° C. Blown film rates are generally from about 5 to about 30 lbs per hour per inch of die circumference. The finished film can be wound into rolls for later processing, or can be fed into a bag machine and converted into bags. A particular blown film process and apparatus suitable for forming films according to embodiments described herein are described in U.S. Pat. No. 5,569,693. Of course, other blown film forming methods can also be used.

In one embodiment, films comprising one or more LLDPE polymers that exhibit a melt index ratio of from about 15 to about 30, a molecular weight distribution (M_{w}/Mₙ) of from about 3.0 to about 4.0, a ratio of z-average molecular weight to weight average molecular weight of from about 2.2 to about 3.0, a second melt temperature of from about 119° C. to about 123° C., and a CDBI of from about 45 to about 75 are used to prepare blown molded films. When normalized to 1 mil film thickness, films of these embodiments preferably exhibit a Dart A Impact Strength ≧1.100×10³ g/mil, particularly ≧1.300×10³ g/mil and an average of the MD and TD 1% Secant Moduli >26.0 kpsi. Films may also have an Elmendorf tear MD (g) of from about 200 to about 1000, a tear TD (g) of from about 400 to about 1000. More preferably these films exhibit, a 1% Secant Modulus in the machine direction of from about 25 kpsi to about 35 kpsi, a 1% Secant Modulus in the transverse direction of from about 25 kpsi to about 35 kpsi, a tensile strength in the machine direction of from about 6000 to about 9000 psi/mil, and a tensile strength in the transverse direction of from about 5000 to about 8000 psi/mil.

In another aspect, any polymer product containing ethylene-based polymer compositions or polymer blend compositions produced by methods known in the art are provided. In addition, also included are products having other specific end-uses, such as film-based products, which include stretch films, shrink films, bags (i.e., shipping sacks, trash bags and liners, industrial liners, and produce bags), flexible and food packaging (e.g., fresh cut produce packaging, frozen food packaging), personal care films, pouches, medical film products (such as IV bags), diaper backsheets, and housewrap. Products may also include packaging, for example by bundling, and unitizing a variety of products. Applications for such packaging include various foodstuffs, rolls of carpet, liquid containers, and various like goods normally containerized and/or palletized for shipping, storage, and/or display.

In some embodiments, stretch cling films may be formed from ethylene-based polymers and polymer blends described herein. The stretch cling films may be monolayer or multilayer, with one or more layers comprising the ethylene-based polymers or blends. In some embodiments, the films may be coextruded, comprising one or more layers made from the ethylene-based polymers or blends described herein, along with one or more layers of traditional Ziegler-Natta or metallocene-catalyzed LLDPE, which may, optionally, include a comonomer such as, for example, hexene or octene.

Some resins and blends described herein may also be suited for use in stretch handwrap films. Stretch film handwrap requires a combination of excellent film toughness, especially puncture and dart drop performance, and a very stiff, i.e., difficult to stretch, film. This film ‘stiffness’ is required to minimize the stretch required to provide adequate load holding force to a wrapped load and to prevent further stretching of the film. The film toughness is required because handwrap loads (being wrapped) are typically more irregular and frequently contain greater puncture requirements than typical machine stretch loads. In some embodiments, the films may be downgauged stretch handwrap films. In further embodiments, ethylene-based polymers and blends may be blended with LDPE, other LLDPEs, or other polymers to obtain a material with characteristics suitable for use in stretch handwrap films.

Further product applications may also include surface protection applications, with or without stretching, such as in the temporary protection of surfaces during manufacturing, transportation, etc. There are many potential applications of articles and films produced from the polymer blend compositions described herein.

The ethylene-based polymers and blends prepared as described herein are also suited for the manufacture of blown film in a high-stalk extrusion process. In this process, a polyethylene melt is fed through a gap (typically 30-50 mm) in an annular die attached to an extruder and forms a tube of molten polymer which is moved vertically upward. The initial diameter of the molten tube is approximately the same as that of the annular die. Pressurized air is fed to the interior of the tube to maintain a constant air volume inside the bubble. This air pressure results in a rapid 3-to-9-fold increase of the tube diameter which occurs at a height of approximately 5 to 10 times the die diameter above the exit point of the tube from the die. The increase in the tube diameter is accompanied by a reduction of its wall thickness to a final value ranging from approximately 0.5 to 2 mils and by a development of biaxial orientation in the film. The expanded tube is rapidly cooled (which induces crystallization of the polymer), collapsed between a pair of nip rolls and wound onto a film roll.

Films composed of ethylene-based polymers or blends thereof show improved performance and mechanical properties when compared to films previously known in the art. For example, films containing the LLDPE polymers and blends described herein have improved seal strength and hot tack performance, increased toughness, and lower reblock. The films also have a good balance of stiffness vs. toughness as indicated by machine direction tear strength, 1% Secant Modulus, and dart drop impact strength performance. In addition, such films may also exhibit higher ultimate stretch and have better processability when compared with other LLDPE resins and blends.

The ethylene-based polymers and blends described herein are also suitable for use in blow molding processes. Blow molding processes may include extrusion and/or injection blow molding. The ethylene-based polymers and blends described herein are also suitable for use in rotational molding processes. Typical properties for rotomolded parts include appearance, and especially in the case of containers, resistance to puncture or rupture, chemical resistance and for extended periods of usefulness, resistance to environmental stress cracking. Low density polyethylene (LDPE) with a density of about 0.900 to about 0.925 g/cm³, linear low density polyethylene (LLDPE) with a density of about 0.926 to about 0.940 g/cm³, and high density polyethylene (HDPE) with a density of about 0.940 to about 0.960 g/cm³ are used in rotomolding applications. LLDPE is said to be preferred for its excellent low temperature impact strength and good environmental stress crack resistance (“ESCR”). In some embodiments, the presently described resins and blends may be used to form injection molded articles. In some embodiments, the ethylene-based polymers and blends described herein are also suitable for use in thermoforming processes, extrusion coating processes and in foamed applications.

Other end use applications include electrical devices including one or more layers formed of or containing any of the LLDPE polymers or polymer blend compositions described herein. Wire and/or cable coating compositions can be essentially the neat ethylene-based polymer or blend, or can further include conventional additives, such as anti-oxidants, fillers, processing co-adjuvants, lubricants, pigments, and/or water-free retardant additives. Wire and/or cable coating compositions can comprise blends of the polymers and blends described herein that further comprise polyolefin homopolymers or copolymers, olefin-ester copolymers, polyesters, polyethers, polyether-polyester copolymers, and mixtures thereof. Specific examples of polymers that can be included in such polymer mixtures include other polyethylenes, polypropylenes, propylene-ethylene thermoplastic copolymers, ethylene-propylene rubbers, ethylene-propylene-diene rubbers, natural rubbers, butyl rubbers, ethylene-vinyl acetate (EVA) copolymers, ethylene-methyl acrylate (EMA) copolymers, ethylene-ethyl acrylate (EEA) copolymers, ethylene-butyl acrylate (EBA) copolymers, and ethylene-α-olefin copolymers.

Suitable fillers include inorganic oxides, or inorganic oxides in hydrate, or hydroxide form. Examples include oxides or hydroxides of aluminum, bismuth, cobalt, iron, magnesium, titanium, zinc, and the corresponding hydrate forms. Hydroxides are generally used in the form of coated particles, wherein the coating is typically a saturated or unsaturated C₈ to C₂₄ fatty acid or a salt thereof, such as, for example, oleic acid, palmitic acid, stearic acid, isostearic acid, lauric acid, magnesium stearate, magnesium oleate, zinc stearate, or zinc oleate. Other suitable fillers include glass particles, glass fibers, calcined kaolin, and talc.

### EXAMPLES

### Test Methods

The properties cited below were determined in accordance with the following test procedures. Where any of these properties is referenced in the appended claims, it is to be measured in accordance with the specified test procedure.

Where applicable, the properties and descriptions below are intended to encompass measurements in both the machine and transverse directions. Such measurements are reported separately, with the designation “MD” indicating a measurement in the machine direction, and “TD” indicating a measurement in the transverse direction.

Gauge, reported in mils, was measured using a Measuretech Series 200 instrument. The instrument measures film thickness using a capacitance gauge. For each film sample, ten film thickness datapoints were measured per inch of film as the film was passed through the gauge in a transverse direction. From these measurements, an average gauge measurement was determined and reported.

Elmendorf Tear, reported in grams (g) or grams per mil (g/mil), was measured as specified by ASTM D-1922.

Tensile Strength at Yield, reported in pounds per square inch (lb/in² or psi), was measured as specified by ASTM D-882.

Tensile Strength at Break, reported in pounds per square inch (lb/in² or psi), was measured as specified by ASTM D-882.

Tensile Strength at 200% Elongation, reported in pounds per square inch (lb/in² or psi), was measured as specified by ASTM D-882.

Ultimate Tensile Strength, reported in pounds per square inch (lb/in² or psi), was measured as specified by ASTM D-882.

Tensile Peak Load, reported in pounds (lb), was measured as specified by ASTM D-882.

Tensile Energy, reported in inch-pounds (in-lb), was measured as specified by ASTM D-882.

Elongation at Yield, reported as a percentage (%), was measured as specified by ASTM D-882.

Elongation at Break, reported as a percentage (%), was measured as specified by ASTM D-882.

1% Secant Modulus (M), reported in pounds per square inch (lb/in² or psi), was measured as specified by ASTM D-882.

Haze, reported as a percentage (%), was measured as specified by ASTM D-1003.

Gloss, a dimensionless number, was measured as specified by ASTM D-2457 at 45°.

Total Energy, reported in foot-pounds (ft-lb), was measured as specified by ASTM D-4272.

Melt Index, I_{2.16}, reported in grams per 10 minutes (g/10 min), refers to the melt flow rate measured according to ASTM D-1238, condition E.

High Load Melt Index, I_{2.16}, reported in grams per 10 minutes (g/10 min), refers to the melt flow rate measured according to ASTM D-1238, condition F.

Melt Index Ratio, a dimensionless number, is the ratio of the high load melt index to the melt index, or I_{2.16}/I_{2.16}.

100% Modulus, reported millipascals (mPa), was measured as specified by ASTM D-412.

300% Modulus, reported in millipascals (mPa), was measured as specified by ASTM D-412.

Density, reported in grams per cubic centimeter (g/cm³), was determined using chips cut from plaques compression molded in accordance with ASTM D-1928 Procedure C, aged in accordance with ASTM D-618 Procedure A, and measured as specified by ASTM D-1505.

Dart Drop Impact (DIS), reported in grams (g) and/or grams per mil (g/mil), was measured as specified by ASTM D-1709, method A.

Peak Puncture Force, reported in pounds (lb) and/or pounds per mil (lb/mil), was determined according to ASTM D-3763.

Puncture Break Energy, reported in inch-pounds (in-lb) and/or inch-pounds per mil (in-lb/mil), was determined according to ASTM D-3763.

Shrink, reported as a percentage, was measured by cutting circular specimens from a film using a 100 mm die. The samples were marked in their respective directions, dusted with talc, and placed on a pre-heated, talc covered tile. The samples were then heated using a heat gun (model HG-501A) for approximately 10 to 45 seconds, or until the dimensional change ceased. An average of three specimens is reported. A negative shrinkage number indicates expansion of a dimension after heating when compared to its pre-heating dimension.

Highlight Ultimate Stretch, reported as a percentage, and Highlight Ultimate Stretch Force, reported in pounds (lb), were measured by a Highlight Stretch tester using a method consistent with Highlight recommended machine settings and normal industry practices. Results are reported as an average of three tests unless otherwise noted.

Highlight Puncture Force, reported in pounds (lb), was measured by a Highlight Stretch tester using a method consistent with Highlight recommended machine settings. Results are reported as an average of two tests unless otherwise noted.

Coefficient of Friction, reported without units, was measured as specified by ASTM D-1894. Persons having ordinary skill in the art will recognize that, with respect to films, coefficient of friction may be measured in a number of configurations. Accordingly, such measurements will be designated as inside surface-to-inside surface (UI), outside surface-to-inside surface (O/I), and outside surface-to-outside surface (0/0).

Izod Impact, reported in foot-pounds per inch, was determined according to ASTM D-4812.

Where any of the above properties are reported in pounds per square inch, grams per mil, or in any other dimensions that are reported per unit area or per unit thickness, the ASTM methods cited for each property have been followed except that the film gauge was measured in accordance with ASTM D-374, method C.

### Ethylene-Based Polymers Used in the Examples

### Examples 1-2

Ethylene-based polymers are prepared by gas-phase polymerization as described above and in U.S. Pat. No. 6,956,088 under the conditions reported in Table 1. The resins of Examples 1 and 2 are made into standard blown films on a GEC Blown Film Line. The GEC line has 2½ inch extruder with barrier screw, 6 inch diameter die, 60 mil die gap, and dual lip air ring with chilled air at approximately 50° F. (10° C.). For this run, the GEC was operated at nominal conditions of 150-190 lbs per hour with a 2.5 blow up ratio (BUR) producing 1.0 mil films. The films contained normal processing additives only with no slip, antiblock or pigment. Properties of the films are presented in Tables 2 and 3.

### Comparative Examples 3-6

Comparative Examples 3-6 correspond to the films reported in Examples 53-56 (respectively) of U.S. patent application Ser. No. 11/789,391, filed Apr. 24, 2007, which are also standard blown films with conventional processing additives only with no slip, antiblock, or pigment. Properties of these films are also presented in Tables 2 and 3.

### Comparative Examples 7-9

Comparative Examples 7-9 represent films made with commercially metallocene catalyzed LLDPE made under the same film processing conditions as prior examples.

TABLE 1

| | Example No. | | | |
|---|---|---|---|---|
| | Example 1 | Example 2 | Comp. Ex. 3 | Comp. Ex. 5 |
| Comonomer | Hexene | Hexene | Hexene | Hexene |
| Production rate | 10000 | 9300 | 9900 | 88000 |
| (lb/h) | | | | |
| Hydrogen | 0.0013 | 0.0014 | 0.034 | 0.091 |
| (mole %) | | | | |
| C2 partial | 163.2 | 163.9 | 210.3 | 196 |
| press. (psia) | | | | |
| C6/C2 | 0.015 | 0.016 | 0.016 | 0.1 |
| concentration | | | | |
| ratio | | | | |
| Temp. | 79.5 | 79.0 | 80.7 | 82.1 |
| (deg. C.) | | | | |
| Residence | 4.4 | 4.7 | 4.5 | 1.8 |
| Time (h.) | | | | |
| M_{w} | 124707 | 150066 | 127338 | 118258 |
| Mₙ | 46212 | 48685 | 33821 | 57445 |
| M_{w}/Mₙ | 2.70 | 3.08 | 3.76 | 2.06 |
| M_{z} | 266611 | 322006 | 318545 | 196929 |
| M_{z}/M_{w} | 2.14 | 2.15 | 2.50 | 1.66 |
| TREF CDBI | 39.9 | 36.6 | 26.6 | 64.3 |
| (%) | | | | |

TABLE 2

| | Example No. | | | | | | | | |
|---|---|---|---|---|---|---|---|---|---|
| | | | Comparative | Comparative | Comparative | Comparative | Comparative | Comparative | Comparative |
| | Example 1 | Example 2 | Ex. 3 | Ex. 4 | Ex. 5 | Ex. 6 | Ex. 7 | Ex. 8 | Ex. 9 |
| Comonomer (mole %) | Hexene | Hexene | Hexene | Hexene | Hexene | Hexene | Hexene | Hexene | Hexene |
| Composition | 100% | 100% | 100% | 95% LLDPE | 100% | 95% LLDPE | 100% | 100% | 100% |
| | LLDPE | LLDPE | LLDPE | 5% LDPE | LLDPE | 5% LDPE | LLDPE | LLDPE | LLDPE |
| Melt Index (I_{2.16}), g/10 | 0.88 | 0.71 | 0.75 | | 1.07 | | 1.0 | 1.0 | 1.0 |
| min | | | | | | | | | |
| High Load MI (I_{21.6}), | 22.26 | 19.59 | 24.6 | | 17.9 | | | | |
| g/10 min | | | | | | | | | |
| Melt Index Ratio | 25.3 | 27.59 | 32.8 | | 16.7 | | | | |
| (I_{21.6}/I_{2.16}) | | | | | | | | | |
| Density (g/cm³) | 0.916 | 0.9142 | 0.9151 | | 0.9144 | | 0.912 | 0.915 | 0.918 |
| Melt Temperature | 415 | 417 | 392 | 394 | 399 | 399 | | | |
| (° F.) | | | | | | | | | |
| Extruder Output (lb/h) | 188 | 191 | 152 | 148 | 150 | 149 | | | |
| Head Pressure (psi) | 3550 | 3960 | 3400 | 3530 | 3470 | 3550 | | | |
| Motor Load (amps) | 50.3 | 46.7 | 67 | 65.8 | 73.8 | 72 | | | |
| Screw Speed (rpm) | 59.9 | 65.5 | 53.4 | 53.4 | 51.4 | 51.4 | | | |
| Line Speed (fpm) | 167 | 167 | 132 | 132 | 132 | 132 | | | |
| Gauge (mils) | 1 | 1 | 1 | 0.99 | 1 | 0.99 | | | |
| FLH (in) | 23 | 22 | 20 | 12 | 15 | 14 | | | |
| ESO (lb/hp-h) | 11.79 | 11.77 | 10.01 | 9.94 | 9.28 | 9.48 | | | |
| Tensile at Yield, MD | 1125 | 1185 | 1170 | 1320 | 1040 | 1130 | 980 | 1100 | 1300 |
| (psi) | | | | | | | | | |
| Tensile at Yield, TD | 1341 | 1315 | 1230 | 1520 | 1030 | 1220 | 960 | 1100 | 1200 |
| (psi) | | | | | | | | | |
| Ultimate Tensile, MD | 10029 | 9741 | 8520 | 8880 | 9150 | 10730 | 7200 | 10000 | 6600 |
| (psi) | | | | | | | | | |
| Ultimate Tensile, TD | 8821 | 8673 | 7680 | 7390 | 8870 | 8580 | 5200 | 8600 | 4600 |
| (psi) | | | | | | | | | |
| Ultimate Elongation, | 402 | 436 | 370 | 330 | 420 | 470 | 450 | 530 | 470 |
| MD (%) | | | | | | | | | |
| Ultimate Elongation, | 647 | 661 | 580 | 590 | 620 | 610 | 540 | 650 | 550 |
| TD (%) | | | | | | | | | |
| 1% Secant Modulus, | 23416 | 24647 | 23660 | 27570 | 17920 | 20850 | 1800 | 21000 | 25000 |
| MD (psi) | | | | | | | | | |
| 1% Secant Modulus, | 33540 | 33052 | 27560 | 39670 | 18990 | 25010 | 1900 | 23000 | 28000 |
| TD (psi) | | | | | | | | | |
| Avg 1% Secant | 28478 | 28849.5 | 25610 | 33620 | 18455 | 22930 | 18500 | 22000 | 26500 |
| Modulus (psi) | | | | | | | | | |
| Puncture Force | 10 | 10 | 11 | 11 | 14 | 15 | | | |
| (lbs/mil) | | | | | | | | | |
| Puncture Energy | 29.3 | 30.2 | 35 | 33 | 53 | 57 | | | |
| (in · lb/mil) | | | | | | | | | |
| Elmendorf Tear, MD | 238 | 231 | 230 | 140 | 200 | 160 | 190 | 230 | 270 |
| (g/mil) | | | | | | | | | |
| Elmendorf Tear, TD | 395 | 387 | 380 | 400 | 360 | 400 | 350 | 350 | 440 |
| (g/mil) | | | | | | | | | |
| Elmendorf Tear, | 0.603 | 0.597 | 0.61 | 0.35 | 0.56 | 0.40 | 0.54 | 0.66 | 0.61 |
| MD/TD Ratio | | | | | | | | | |
| Dart Drop A (g) | >1367 | >1367 | 1400+ | 1180 | 1190 | 1080 | 590 | 890 | 580 |
| Dart Drop A per mil | >1353 | >1327 | no break | 1150 | 1160 | 1100 | 590 | 890 | |
| Gauge (mils) | 1.04 | 1.03 | 1.02 | 1.01 | 1.02 | 0.98 | 1.0 | 1.0 | |
| Shrink, MD (%) | 68 | 64 | 65 | 71 | 54 | 60 | | | |
| Shrink, TD (%) | −17 | −16 | −5 | −1 | −5 | −6 | | | |
| Reblock (g) | >214 | >214 | 26 | 210 | 132 | 190 | | | |
| Haze (%) | 10.7 | 10.8 | 33 | 5.8 | 7.9 | 1.8 | 11 | 17 | 17 |

TABLE 3
Heat Seal Performance

| | Example No. | | | | |
|---|---|---|---|---|---|
| | Example 1 | Example 2 | Comp. Ex. 7 | Comp. Ex. 8 | Comp. Ex. 9 |
| Material | 1 mil, 2.5 BUR | 1 mil, 2.5 BUR | 1 mil, 2.5 BUR | 1 mil, 2.5 BUR | 1 mil, 2.5 BUR |
| | 60 mil die gap | 60 mil die gap | Exceed 1012 | Exceed 1015 | Exceed 1018 |
| | Seal Strength | Seal Strength | Seal Strength | Seal Strength | Seal Strength |
| | (g/cm) | (g/cm) | (g/cm) | (g/cm) | (g/cm) |
| Temperature (° C.) | | | | | |
| 65 | | 7.14 | | | |
| 70 | | 10.71 | | | |
| 75 | 10.71 | 23.22 | | | |
| 80 | 16.07 | 57.15 | 7.14 | | |
| 85 | 35.72 | 226.80 | 16.07 | | |
| 90 | 75.00 | 298.23 | 244.65 | 8.93 | |
| 95 | 312.51 | 308.94 | 296.44 | 26.79 | 8.93 |
| | (min) | (min) | (min) | (min) | (min) |
| 100 | 332.16 | 321.44 | 355.37 | 298.23 | 16.07 |
| 105 | 330.37 | 326.80 | 358.94 | 332.16 | 305.37 |
| 110 | 332.16 | 325.01 | 362.51 | 373.23 | 350.01 |
| 115 | 333.94 | 339.30 | 371.44 | 387.52 | 369.66 |
| | | | | (max) | |
| 120 | 350.01 | 330.37 | 360.73 | 371.44 | 357.16 |
| 125 | 341.09 | 348.23 | 369.66 | 362.51 | 355.37 |
| 130 | 342.87 | 353.59 | 391.09 | 358.94 | 373.23 |
| | | | | | (max) |
| 135 | 358.94 | 339.30 | 400.02 | 364.30 | 358.94 |
| | | | (max) | | |
| 140 | 364.30 | 358.94 | 387.52 | 373.23 | 323.23 |
| | (max) | (max) | | | |
| Str (max) − Str (min) | 51.79 | 50.00 | 103.58 | 360.73 | 364.30 |
| (95° C. < T < 140° C.) | | | | | |

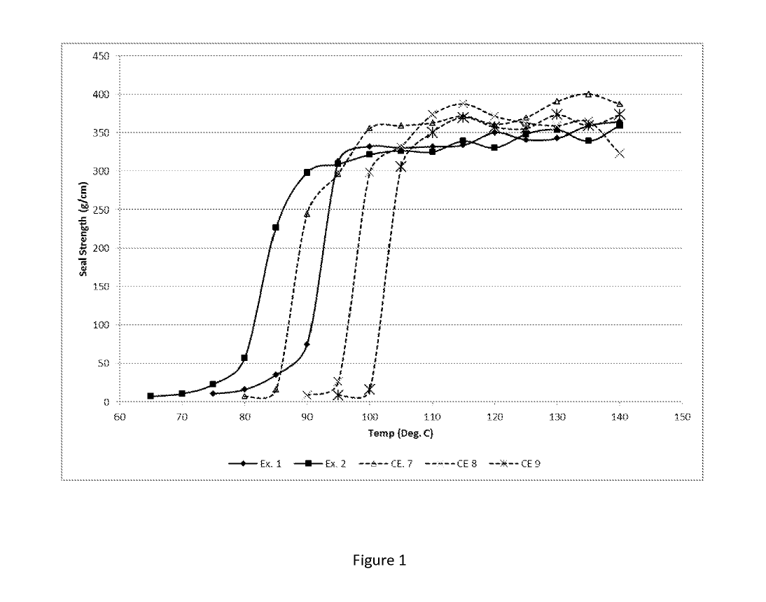

The data in Tables 2 and 3 show that the films of the inventive resins have a unique balance of properties. As shown in FIG. 1, the films have a seal strength that is relatively constant over a broad range of sealing temperatures, which advantageously reduces the need to strictly control sealing conditions. In addition, some films have a balance of improved stiffness as indicated by 1% Secant Modulus and a high Dart Impact strength. One approach for comparing film data is to compare films of equivalent stiffness as indicated by 1% Secant Modulus, because films are frequently used in applications that require stiffness for adequate end-use performance. Some films also have and balanced stiffness as measured by the average of the MD and TD values of the 1% Secant Modulus, e.g., 26,000-35,000 psi, 28,000 to 32,000 psi. These data also show that reblock behavior is surprisingly improved in these films. One skilled in the art will recognize that the performance of the inventive resins may readily be adjusted as needed to take advantage of this superior performance. For example, inventive resin density can be reduced, resulting in a softer film (like the control) with further toughness enhancement.

TABLE 4
Heat Tack Performance

| | Example No. | | | | |
|---|---|---|---|---|---|
| | Example 1 | Example 2 | Comp. Ex. 7 | Comp. Ex. 8 | Comp. Ex. 9 |
| | 1 mil, 2.5 BUR | 1 mil, 2.5 BUR | 1 mil, 2.5 BUR | 1 mil, 2.5 BUR | 1 mil, 2.5 BUR |
| | 60 mil die gap | 60 mil die gap | 60 mil die gap | 60 mil die gap | 60 mil die gap |
| | Hot Tack | Hot Tack | Hot Tack | Hot Tack | Hot Tack |
| | Strength | Strength | Strength | Strength | Strength |
| Temperature (C.) | (N/25.4 mm) | (N/25.4 mm) | (N/25.4 mm) | (N/25.4 mm) | (N/25.4 mm) |
| 75 | | 0.27 | | | |
| 80 | 0.22 | 0.74 | 0.23 | | |
| 85 | 0.44 | 1.89 | 0.67 | | |
| 90 | 1.04 | 4.43 | 2.68 | 0.24 | |
| 95 | 5.12 | 8.71 | 15.40 | 0.80 | |
| 100 | 12.14 | 11.96 | 14.05 | 9.93 | 0.25 |
| 105 | 9.48 | 9.60 | 9.62 | 9.68 | 7.72 |
| 110 | 8.15 | 8.28 | | 7.99 | 7.99 |
| 115 | | | | | 8.17 |
| 120 | | | | | 7.24 |
| 125 | | | | | 6.24 |

Hot Tack Measurement Conditions: Sealed I/I, Seal Pressure = 0.5, Seal Time = .50 sec., Peel Speed = 200 mm/sec., Backed with 2 mil PET tape

Any range of numbers recited in the specification hereinabove or in the claims hereinafter, such as that representing a particular set of properties, units of measure, conditions, physical states or percentages, is intended to literally incorporate expressly herein by reference or otherwise, any number falling within such range, including any subset of numbers or ranges subsumed within any range so recited.

All documents referred to above are incorporated by reference herein in their entirety unless stated otherwise, including any priority documents and/or testing procedures to the extent they are not inconsistent with this text, provided however that any priority document not named in the initially filed application or filing documents is NOT incorporated by reference herein. As is apparent from the foregoing general description and the specific embodiments of the invention, while forms of the invention have been illustrated and described, various modifications can be made without departing from the spirit and scope of the invention. Accordingly, it is not intended that the invention be limited thereby. In some embodiments of the invention, the composition is substantially free (i.e., present only at impurity levels or not purposely added to a described composition) of any additive or component not specifically enumerated herein. Advantages described for certain embodiments may or may not be present in other embodiments. Likewise, the term “comprising” is considered synonymous with the term “including” for purposes of Australian law. Likewise whenever a composition, an element or a group of elements is preceded with the transitional phrase “comprising”, it is understood that we also contemplate the same composition or group of elements with transitional phrases “consisting essentially of,” “consisting of”, “selected from the group consisting of,” or “is” preceding the recitation of the composition, element, or elements and vice versa.

What is claimed is:

1. A polymer composition comprising:
an ethylene-based polymer having:
i. a melt index of from 0.1 g/10 min to 5.0 g/10 min;
ii. a melt index ratio of from 15 to 30;
iii. a weight average molecular weight (Mw) of from 20,000 to 200,000;
iv. a molecular weight distribution (Mw/Mn) of from 2.0 to 4.5; and
v. a density of from 0.900 to 0.920 g/cm³, and
wherein the difference between the maximum seal strength and the minimum seal strength over the range of temperatures between 95.0° C. and 140.0° C. is ≦1.00×10² grams/cm.

2. The polymer composition of claim 1, wherein the difference between the maximum seal strength and the minimum seal strength over the range temperatures between 95.0° C. and 140.0° C. is 0.20×10² grams/cm to 0.85×10² grams/cm.

3. The polymer composition of claim 1, wherein the difference between the maximum seal strength and the minimum seal strength over the range temperatures between 95.0° C. and 140.0° C. is 0.40×10² grams/cm to 0.60×10² grams/cm.

4. The polymer composition of claim 3, wherein the ethylene-based polymer has a CDBI of from 20% to 35%.

5. The polymer composition of claim 4 having a Dart A Impact Strength ≧1.100×10³ g/mil and an average modulus of the MD and TD 1% Secant Moduli >26.0 kpsi.

6. The polymer composition of claim 4 having a Dart A Impact Strength ≧1.300×10³ g/mil and an average modulus of the MD and TD 1% Secant Moduli >28.0 kpsi.

7. The polymer composition of claim 6, wherein said ethylene-based polymer further comprises up to 5 mole % units derived from an alpha-olefin comonomer.

8. An article of manufacture, wherein said article comprises the polymer composition of claim 1, and wherein said article is formed by a manufacturing process selected from the group consisting of injection molding, rotational molding, blow molding, extrusion coating, foaming, casting, and combinations thereof.

9. An article of manufacture, wherein said article comprises the polymer composition of claim 1, and wherein said article is an extruded blown or cast film, or a combination thereof.

10. An article of manufacture according to claim 8, wherein said article is an extruded monolayer or multilayer film.

11. An article of manufacture according to claim 8, wherein said article is an extruded multilayer film, wherein a heat seal layer of the multilayer film comprises the polymer composition.

12. A film comprising:
at least one ethylene-based polymer having:
i. a melt index of from 0.1 g/10 min to 5.0 g/10 min;
ii. a melt index ratio of from 15 to 30;
iii. a weight average molecular weight (Mw) of from 20,000 to 200,000;
iv. a molecular weight distribution (Mw/Mn) of from 2.0 to 4.5; and
v. a density of from 0.900 to 0.920 g/cm³, and
wherein the difference between the maximum seal strength and the minimum seal strength over a range of temperatures between 95.0° C. and 140.0° C. is ≦1.00×10² grams/cm.

13. The film of claim 12, wherein the difference between the maximum seal strength and the minimum seal strength over the range of temperatures between 95.0° C. and 140.0° C. is 0.40×10² grams/cm to 0.60×10² grams/cm.

14. The film of claim 12, wherein the ethylene-based polymer has a CDBI of from 20% to 35%.

15. The film of claim 12 having a Dart A Impact Strength ≧1.100×10³ g/mil and an average modulus of the MD and TD 1% Secant Moduli >26.0 kpsi.

16. The film of claim 12 having a Dart A Impact Strength ≧1.300×10³ g/mil and an average modulus of the MD and TD 1% Secant Moduli >28.0 kpsi.

17. The film of claim 12, wherein said ethylene-based polymer further comprises up to 5 mole % units derived from an alpha-olefin comonomer.

18. The film of claim 12 having an Elmendorf tear in the machine direction of 200 to 1000 g/mil.

19. The film of claim 12, wherein the film has:
i. a 1% secant modulus in the machine direction of from 25 to 35 kpsi;
ii. a 1% secant modulus in the transverse direction of from 25 kpsi to 35 kpsi;
iii. a tensile strength in the machine direction of from 6000 kpsi to 9000 psi; and
iv. a tensile strength in the transverse direction of from 5000 kpsi to 8000 psi/mil.

20. The film of claim 12, wherein the seal initiation temperature is within the range of temperatures between 75.0° C. and 85.0° C.

21. A film according to claim 12, wherein the film thickness is less than 0.8 mils.

22. A film according to claim 12, wherein the film thickness is less than 0.6 mils.

23. A film according to claim 12, wherein the film thickness is less than 0.4 mils.

24. An ethylene/alpha-olefin copolymer characterized by: a melt index of from 0.1 g/10 min to 5.0 g/10 min; a melt index ratio of from 15 to 30; a weight average molecular weight (Mw) of from 20,000 to 200,000; a molecular weight distribution (Mw/Mn) of from 2.0 to 4.5; and a density of from 0.900 to 0.920 g/cm³; having a Dart A Impact >1200 g/mil and an average 1% Secant Modulus of ≧2.65×10⁴ psi when formed into a film.

25. A film comprising an ethylene/alpha-olefin copolymer characterized by: a melt index of from 0.1 g/10 min to 5.0 g/10 min; a melt index ratio of from 15 to 30; a weight average molecular weight (Mw) of from 20,000 to 200,000; a molecular weight distribution (Mw/Mn) of from 2.0 to 4.5; and a density of from 0.900 to 0.920 g/cm³; having a Dart A Impact >1200 g/mil and an average 1% Secant Modulus of ≧2.65×10⁴ psi.

26. A film comprising at least one layer including an ethylene/alpha-olefin copolymer characterized by: a melt index of from 0.1 g/10 min to 5.0 g/10 min; a melt index ratio of from 15 to 30; a weight average molecular weight (Mw) of from 20,000 to 200,000; a molecular weight distribution (Mw/Mn) of from 2.0 to 4.5; and a density ≦0.9160 g/cm³; the film having an average 1% Secant Modulus of ≧2.65×10⁴ psi and/or a Dart A Impact >1200 g/mil.
